(19) United States
(12) Patent Application Publication
(10) Pub. No.: US 2007/0259652 A1
(43) Pub. Date: Nov. 8, 2007

(54) Wireless Switches Incorporating a Light Source

(75) Inventors: Josh ROSENTHAL, San Jose, CA (US); Sameer Kanagala, San Carlos, CA (US); Edward Geiger, San Martin, CA (US); Michael Suekawa, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: SYMBOL TECHNOLOGIES, INC., Holtsville, NY (US)

(21) Appl. No.: 11/742,251

(22) Filed: Apr. 30, 2007

Related U.S. Application Data
(60) Provisional application No. 60/797,018, filed on May 1, 2006.

(51) Int. Cl. H04Q 7/38

(52) U.S. Cl. 455/414.1

(57) ABSTRACT

A wireless switch of the type used in a wireless local area network (WLAN) is provided. The wireless switch includes a main processing element; a housing that houses the main processing element, the housing having a first side and a second side; a user interface coupled to the main processing element and accessible on the first side of the housing; and a light source coupled to the main processing element and configured to emit light at the second side of the housing when the user interface is activated.

### CROSS-REFERENCES TO RELATED APPLICATIONS

This application claims the benefit of U.S. Provisional Application No. 60/797,018, filed May 1, 2006.

### FIELD OF THE INVENTION

The present invention generally relates to wireless switches, and more particularly relates to wireless switches incorporating a light source.

### BACKGROUND OF THE INVENTION

In recent years, there has been a dramatic increase in the demand for mobile connectivity solutions utilizing various wireless components and wireless networks, for example, wireless local area networks (WLANs). WLANs generally include, among other things, wireless switches and access ports that communicate with mobile units using one or more RF channels. A WLAN may operate in accordance with one or more of the IEEE 802.11 standards.

WLANs can give clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices. Conventional wireless switches generally function as network interfaces between wireless access devices and a traditional computer network, such as a local area network (LAN).

Wireless switches are typically grouped together on racks. A group of wireless switches can have, for example, twenty or thirty wireless switches. While certain components and ports are accessible from the front of a particular wireless switch, some aspects of the wireless switch, such as a power input, are only accessible from the rear. When dealing with a large number of switches, it can be difficult for a technician or user to identify a rear side of a particular switch.

Accordingly, it is desirable to provide a scheme for locating a particular switch in a group of switches. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and wherein:

FIG. 1 is a conceptual overview of a wireless network in accordance with an exemplary embodiment of the present invention;

FIG. 2 is a schematic representation of a wireless switch of the wireless network of FIG. 1;

FIG. 3 is a front perspective view of a wireless switch in accordance with an exemplary embodiment of the present invention;

FIG. 4 is a back perspective view of a wireless switch in accordance with an exemplary embodiment of the present invention; and

FIG. 5 is a schematic representation of a wireless switch in accordance with an exemplary embodiment of the present invention in a group of switches.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely exemplary applications for the invention.

For the sake of brevity, conventional techniques related to WLANs, signal processing, data transmission, signaling, network control, the 802.3 and 802.11 families of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

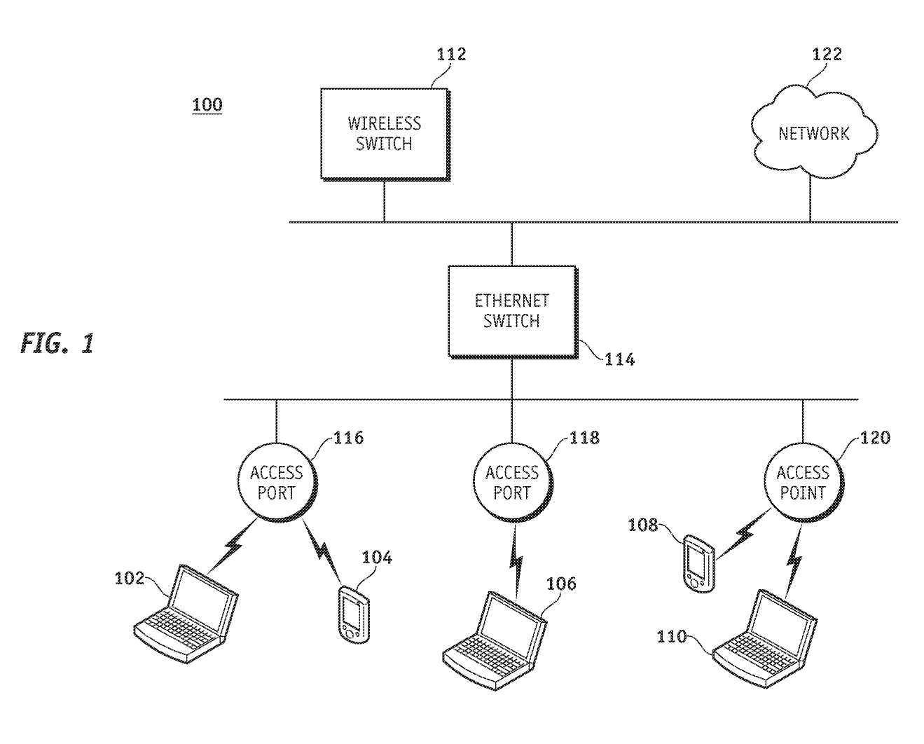

FIG. 1 is a schematic representation of a computer network 100 configured in accordance with an example embodiment of the invention. In this example, computer network 100 includes a WLAN. The computer network 100 generally includes wireless clients (identified by reference numbers 102, 104, 106, 108, and 110), a wireless switch 112, an Ethernet switch 114, and a number of wireless access devices (identified by reference numbers 116, 118, and 120). The computer network 100 may also include or communicate with any number of additional network components, such as a traditional local area network (LAN). In FIG. 1, such additional network components are generally identified by reference number 122. A practical embodiment can have any number of wireless switches, each supporting any number of wireless access devices, and each wireless access device supporting any number of wireless clients. Indeed, the topology and configuration of the computer network 100 can vary to suit the needs of the particular application and FIG. 1 is not intended to limit the application or scope of the invention in any way.

In this example, the wireless access devices 116, 118 are realized as wireless access ports, which are “thin” devices that rely on the network intelligence and management functions provided by the wireless switch 112, while wireless access device 120 is realized as a wireless access point, which is a “thick” device having the network intelligence and processing power integrated therein. Thus, the wireless access device 120 need not rely upon the wireless switch 112 for operation. Wireless access ports having conventional features that can be incorporated into the wireless access devices 116, 118, and wireless access points having conventional features that can be incorporated into the wireless access device 120 are available from Symbol Technologies, Inc. Briefly, a wireless access device as described herein is suitably configured to receive data from wireless clients over wireless links. Once that data is captured by the wireless access device, the data can be processed for communication within the computer network 100. For example, the data can be encapsulated into a packet format compliant with a suitable data communication protocol. In the example embodiment, data is routed within the computer network 100 using conventional Ethernet 802.3 addressing (including standard Ethernet destination and source packet addresses).

The wireless switch 112 is coupled to the Ethernet switch 114, which is in turn coupled to the wireless access devices 116, 118, 120. In practice, the wireless switch 112 communicates with the wireless access devices 116, 118 via the Ethernet switch 114. A given wireless switch can support any number of wireless access devices, i.e., one or more wireless access devices can be concurrently adopted by a single wireless switch (in one embodiment, a wireless access device can be adopted by only one wireless switch at a time). The wireless clients are wireless devices that can physically move around the computer network 100 and communicate with the network components 122 via the wireless access devices 116, 118, 120.

The wireless switch 112 may include various advantageous features. For example, the wireless switch 112 may utilize a field programmable gate array (FPGA) to perform the switching code. The wireless switch 112 may also be suitably configured to accept a CompactFlash card or other portable nonvolatile memory device to assist with reloading the wireless switch 112 after initial switch activation. Moreover, a USB port can be included on the exterior of the wireless switch 112 for interfacing with one or more USB devices. Another feature of the wireless switch 112 relates to the use of a boot halt to allow the user to halt the boot process in order to enter a diagnostic mode, thereby allowing advanced troubleshooting. In accordance with another feature of the wireless switch 112, booting is initiated via a NAND switch rather than a NOR switch as used in existing wireless switch devices.

The wireless switch 112 can include a physical housing that surrounds and protects the components of the wireless switch 112. A number of features, elements, and components of the wireless switch 112 may be accessible from the exterior of housing. In this example, most of these accessible and/or viewable features are located at the front face panel of wireless switch 112. In this regard, wireless switch 112 may include, without limitation: one or more system LED lights; an out-of-band management port; one or more USB ports; one or more memory card slots; and various Ethernet connectors, jacks, or ports.

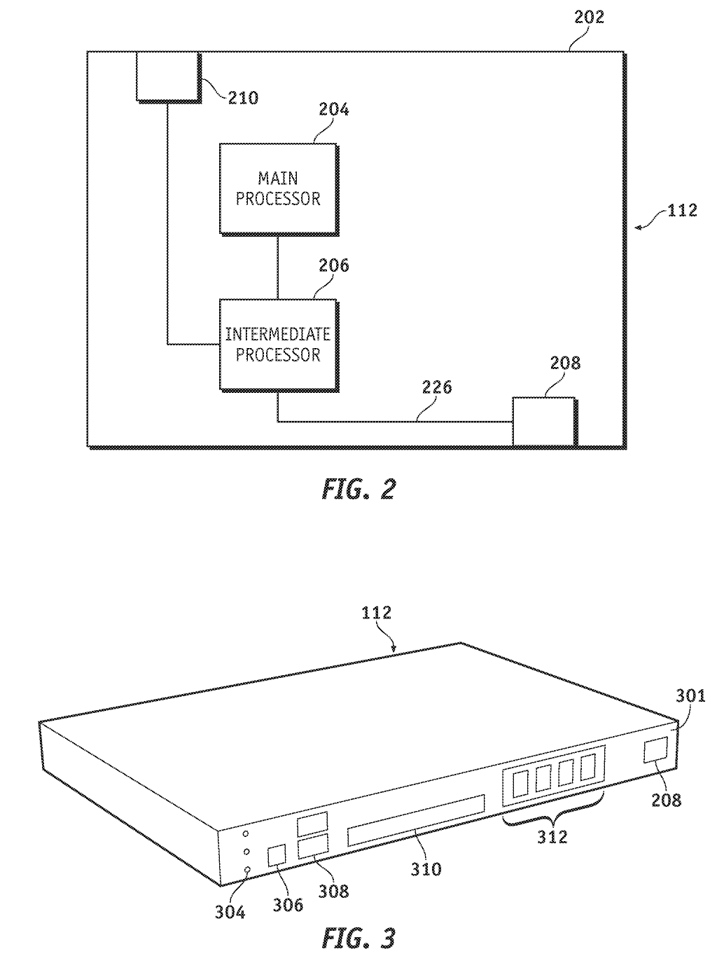

FIG. 2 is a schematic representation of the wireless switch 112 configured in accordance with an exemplary embodiment of the invention. A practical embodiment of the wireless switch 112 will include components and elements configured to support known or conventional operating features that need not be described in detail herein. Accordingly, FIG. 2 is a simplified illustration that omits elements that might otherwise be found inside the wireless switch 112.

The wireless switch 112 generally includes a housing 202, a main processing element (main processor) 204, an intermediate processing element (intermediate processor) 206, a user interface 208, and a light source 210. These and other elements of wireless switch 112 may be interconnected together using a bus 226 or any suitable interconnection arrangement. Such interconnection facilitates communication between the various elements of the wireless switch 112. In this example embodiment, all of the illustrated components other are located within or on the housing 202, which represents the physical package for the wireless switch 112.

The main processing element 204 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

The main processing element 204 is primarily responsible for the general operation of wireless switch 112, e.g., switching, data communication, and wireless packet processing. In contrast, intermediate processing element 206 is primarily responsible for handling inputs and outputs for wireless switch 112 and for managing peripherals for wireless switch 112 (intermediate processing element 206 is suitably configured to perform the various functions described in more detail below). Thus, main processing element 204 and intermediate processing element 206 represent the processing logic that carries out the functions, techniques, and processing tasks associated with the operation of wireless switch 112.

The intermediate processing element 206 may be implemented or realized in the manner described above for main processing element 204. In some exemplary embodiments, intermediate processing element 206 is realized as a field programmable gate array (FPGA). The intermediate processing element 206 can function as an interface, a data translator, and/or a data pass-through element for wireless switch 112. The intermediate processing element 206 also monitors thermal sensors and fan speeds and takes corrective action when thermal sensors detect thermal threshold crossing or fans speeds drop below RPS thresholds. These actions include but are not limited to: lowering processor speed to reduce power consumption, raising fan speeds to increase airflow, and holding the processor in reset. In an alternate embodiment, the intermediate processing element 206 can be omitted, and the functions of the intermediate processing element 206 described herein can be performed by the main processing element 204.

As noted above, the wireless switch 112 further includes the user interface 208 and the light source 210 coupled to the intermediate processing element 206. When a user activates the user interface 208, a suitable signal is sent to the light source 210 via the intermediate processing element 206 such that the light source 210 emits a visible light. The intermediate processing element 206 can include a timer that enables the light source 210 to emit light for a predetermined amount of time. The predetermined amount of time can be, for example, 30 seconds, and can be set by the manufacturer or user. Alternatively, the user interface 208 can have two positions, an “on” position and an “off” position, and the light source 210 will emit light continuously as long as the user interface 208 is in the “on” position.

The light source 210 can produce an intermittent or continuous light in any suitable color. In an exemplary embodiment, the light source 210 is one or more LEDs. The light source 210 can be replaced by any suitable indicator, such as an audible or vibrating indicator, or a non-LED light source. The user interface 208 can be a button, switch, flip toggle, dial, or any other suitable user interface. As discussed in further detail below in reference to FIGS. 3-5, the light source 210 on the rear of the wireless switch 112 enables identification of a particular switch in a group of switches and/or the illumination of an area behind the wireless switch 112. The light source 210 can be housed within the housing 202 and/or on the housing 202.

The wireless switch 112 can further include a network communication module (not shown) that generally represents the hardware, software, firmware, processing logic, and/or other components of wireless switch 112 that enable bidirectional communication between wireless switch 112 and network components to which wireless switch 112 is connected. The wireless switch 112 may include a suitable amount of memory (not shown), such as RAM memory, flash memory, ROM memory, EPROM memory, EEPROM memory, registers, a hard disk, a removable disk, a CD-ROM, or any other form of storage medium known in the art. In one embodiment, the wireless switch 112 can include a boot device selector representing a selection feature in the wireless switch 112 that can be manipulated to control the manner in which the wireless switch 112 boots up in response to a reset command and/or a power-up condition. The wireless switch 112 can include a USB interface suitably configured to facilitate data communication with USB compliant devices.

FIG. 3 is a perspective view of a front side 301 of the wireless switch 112 configured in accordance with an embodiment of the invention. The wireless switch 112 includes various advantageous features. For example, the wireless switch 112 may utilize a field programmable gate array (FPGA) to perform certain logic functions within the switch. In addition, a computer-based processor may be included within the wireless switch 112—i.e., an application processor serving as an adjunct to the processor running the switch software. This allows, for example, a server to be incorporated into the wireless switch 112. The processor might also be a voice processor and a DSP interface, thereby creating a PBX within the switch.

The wireless switch 112 includes a physical housing 302 that surrounds and protects the components of the wireless switch 112. A number of features, elements, and components of the wireless switch 112 may be accessible from the exterior of housing 302. In this example, most of these accessible and/or viewable features are located at the front side 301 of the wireless switch 112. In this regard, the wireless switch 112 may include, without limitation: one or more system LED lights 304; an out-of-band management port 306; one or more USB ports 308; one or more memory card slots 310; and various Ethernet connectors, jacks, or ports 3 12.

The system LED lights 304 are configured to provide a visual indication of the operating condition of the wireless switch 112. The system LED lights 304 may, for example, indicate system status, fan status, thermal status, or the like. The out-of-band management port 306 provides an alternate and direct route to the management port of each device that can be used for reconfiguration, troubleshooting, and rebooting. The USB port 308 is configured for compatibility with USB devices and USB cables. The wireless switch 112 may include any number of USB ports 308 that are accessible from outside the housing 302. The memory card slot 310 is suitably configured to receive a compatible nonvolatile memory storage card. In this regard, memory card slots 310 may be designed to accommodate any number of memory card form factors including, without limitation: CompactFlash; Secure Digital (SD); Memory Stick; MultiMediaCard (MMC); ExpressCard; PCMCIA; or SmartMedia (SM). The ethernet connectors 312 facilitate connection of the wireless switch 112 to various WLAN or LAN components. In this regard, Ethernet connectors 312 may be realized as standard RJ-45 connectors, standard Small Form-Factor Pluggable (SFP) connectors, or the like.

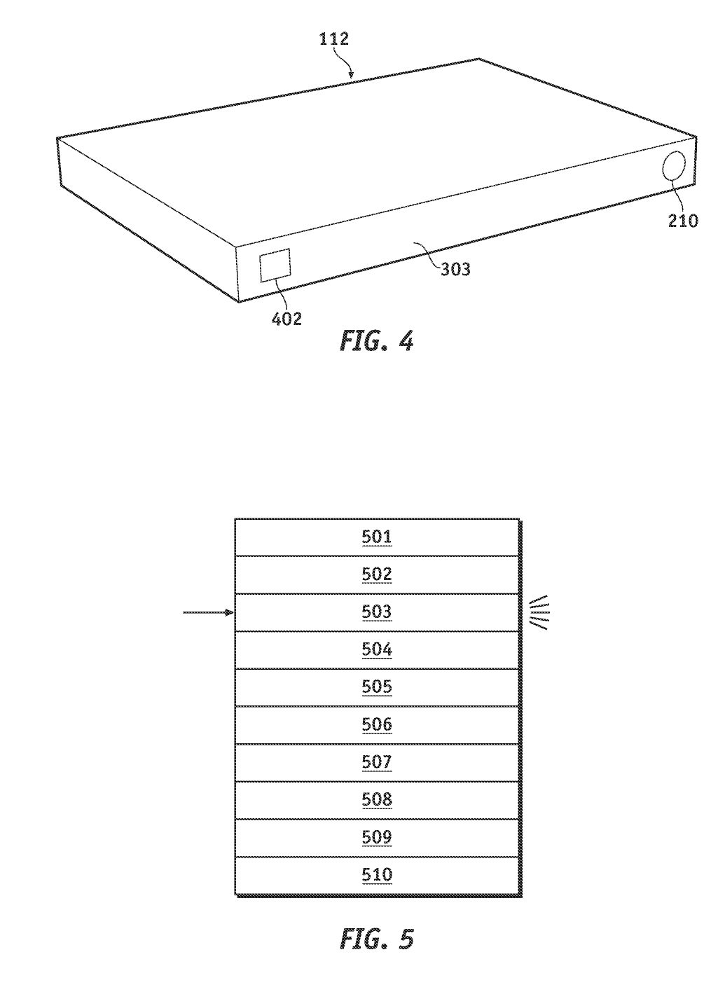

FIG. 3 additionally illustrates the user interface 208, which is also discussed above in reference to FIG. 2. In this embodiment, the user interface 208 is a button. As shown in FIG. 4, which shows a rear side 303 of the wireless switch 112, when the user interface 208 is depressed, the light source 210 emits a light that enables identification of the wireless switch 112 from the rear for the purpose of, for example, disconnecting or connecting a power cord from a power connector 402.

Referring to FIG. 5, wireless switches 501-510 are typically arranged in groups in one or more racks. In accordance with an exemplary embodiment of the present invention, if a user wants to interact with the rear of a particular wireless switch 503, a user can activate a user interface (e.g., user interface 208) on the particular wireless switch 503 that turns on an LED (e.g., light source 210) such that the user can identify the particular wireless switch 503 from the rear.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A wireless switch of the type used in a wireless local area network (WLAN), the wireless switch comprising:
a main processing element;
a housing that houses the main processing element, the housing having a first side and a second side;
a user interface coupled to the main processing element and accessible on the first side of the housing; and
a light source coupled to the main processing element and configured to emit light at the second side of the housing when the user interface is activated.

2. The wireless switch of claim 1, further comprising an intermediate processing element coupled to the main processing element, the user interface, and the light source, wherein the intermediate processing element provides a signal to the light source in response to the activation of the user interface.

3. The wireless switch of claim 2, wherein the intermediate processing element includes a field programmable gate array (FPGA).

4. The wireless switch of claim 2, wherein the intermediate processing element includes a timer that controls the light source.

5. The wireless switch of claim 4, wherein the timer causes the light source to emit light for a predetermined amount of time.

6. The wireless switch of claim 5, wherein the predetermined amount of time is 30 seconds.

7. The wireless switch of claim 1, wherein the second side is a rear side of the housing.

8. The wireless switch of claim 7, wherein the light source is mounted on the rear side of the housing.

9. The wireless switch of claim 1, wherein the user interface is a button.

10. The wireless switch of claim 1, wherein the light source is at least one LED.

11. A wireless local area network (WLAN) comprising:
a plurality of wireless switches coupled to a network and including a first wireless switch, the first wireless switch comprising a main processing element, a housing that houses the main processing element, the housing having a first side and a second side, a user interface coupled to the main processing element and accessible on the first side of the housing, and a light source coupled to the main processing element and configured to emit light at the second side of the housing when the user interface is activated; and
a plurality of wireless access devices configured to receive outgoing data packets from the plurality of wireless switches and to provide incoming data packets to the plurality of wireless switches.

12. The wireless local area network (WLAN) of claim 11, wherein the first wireless switch further comprises an intermediate processing element coupled to the main processing element, the user interface, and the light source, wherein the intermediate processing element provides a signal to the light source in response to the activation of the user interface.

13. The wireless local area network (WLAN) of claim 12, wherein the intermediate processing element includes a field programmable gate array (FPGA).

14. The wireless local area network (WLAN) of claim 12, wherein the intermediate processing element includes a timer that controls the light source.

15. The wireless local area network (WLAN) of claim 14, wherein the timer causes the light source to emit light for a predetermined amount of time.

16. The wireless local area network (WLAN) of claim 15, wherein the predetermined amount of time is 30 seconds.

17. The wireless local area network (WLAN) of claim 11, wherein the second side of the housing is a rear side of the housing.

18. The wireless local area network (WLAN) of claim 17, wherein the light source is mounted on the rear side of the housing.

19. The wireless local area network (WLAN) of claim 11, wherein the user interface is a button.

20. The wireless local area network (WLAN) of claim 11, wherein the light source is at least one LED.
